(19) United States
(12) Patent Application Publication
(10) Pub. No.: US 2003/0009590 A1
(43) Pub. Date: Jan. 9, 2003

(54) Computer system which learns from the experiences of itself and its peers

(76) Inventor: Sheldon O. Linker, Irvine, CA (US)

Correspondence Address: Sheldon O. Linker, 13612 Onkayha Circle, Irvine, CA, 92620, US

(21) Appl. No.: 09/901,276

(22) Filed: Jul. 9, 2001

(51) Int. Cl. G06F 15/173

(52) U.S. Cl. 709/241; 709/206

(57) ABSTRACT

Systems and methods are disclosed which allow a computer system or group of systems to improve their programming, knowledge, and usability with continued use. By providing ever-increasing capabilities to users, both on-line and off-line, this method may improve customer service, give users capabilities never before available to them, and help companies automate many of their data processing and research needs.

### FIELD OF THE INVENTION

This method relates to the field of computer programming and technical support. In particular, this method provides systems and methods for the creation and maintenance of a world-wide computer network which learns from its overall experiences and which appears to be single, personal computer systems to most of its users.

### BACKGROUND OF THE INVENTION

Currently, when someone acquires a piece of computer software, the program has one or more fixed features, usually documented in a manual. From time to time, the manufacturer of this software may issue updates, which the users of the software must install to take advantage of. Users of the software may want to do things that the software is not capable of, or will not do. To correct for this, users will sometimes make a request to the manufacturer of the software that enhancements be added in a later version.

Several problems and deficiencies are present in the current situation:

Users may have to wait months for their upgrades.

Users must take affirmative action to request enhancements from the manufacturers.

Users must know how to use a system in order to take advantage of the features.

All of this leads to two classes of computer users: The standard “user”, and the “guru”. And the typical user, without assistance of the “guru”, may never get done what he needs.

### SUMMARY OF THE INVENTION

This method provides a system and method for the user's computer system to attempt to understand what the user is asking for, in natural language, and to accommodate the user's request or question. If the system does not understand, it will immediately request the assistance of the “Master Computer”, via the internet or any other networking or communication method (hereinafter, “The Network”), and seek assistance there. If this master computer is not able to help the user immediately, it will ask for human assistance. Throughout this document, I refer to the Master Computer as if it were a single computer. The Master Computer may be a single computer, or any number or combination of devices which perform the functions of the Master Computer described herein, whether located at one physical location or spread out, or at one TCP or other address or at multiple addresses.

This human assistance usually results in a change or addition to the Master Computer's data and/or programming. This change, in turn, is securely relayed to the user's computer so that it may now perform the requested function or answer the question at hand. Security is often important, since the user's system must not be modified, reprogrammed, or misinformed by third parties. (This document also specifies a faster, less secure method which may be preferable when this method is used on a network which enforces or has enforced upon it some other form of security. For instance, a corporation's internal, isolated network.)

Other similar computer systems around the world are immediately able to take advantage of this new knowledge or functionality because it now resides in the Master Computer system.

This method applies both to programs and systems which attempt to learn from their use and the use of their peers, and to programs and systems which need to be updated for other reasons on a periodic basis.

### PRIOR ART

All of the requisite pieces needed to create and use this new method, including the internet, local area networks, electronic mail, and computers exist and are in wide use, and are in the public domain. The idea of a computer system learning from the use of its peers is not only not in any patent list, but not even present in science fiction stories!

Japanese patent #JP03237530A2 describes a system whereby a central computer transmits a list of modules which can be downloaded, and the client computer then downloads them. This method has similar intent, in that the client is to do an update, but simpler, in that only a notification of availability is needed, and more useful, in that the process is driven by the users of the client computers. (Details: Country: Japan; Inventor: Kumano Kiichi; Applicant(s): NEC Corporation; Issued/Filed Dates: Oct. 23, 1991/Feb. 14, 1990; Application Number: JP1990000034131; IPC Class: G06F 9/445; G06F 13/00)

### BRIEF DESCRIPTION OF THE DRAWINGS

FIG. 1 is a flowchart illustrating the on-line process optimally used in answering a question or fulfilling a request.

FIG. 2 is a flowchart illustrating the off-line process used in answering a question or fulfilling a request when the on-line process is not sufficient.

FIG. 3 is a flowchart illustrating the off-line process used to initiate an update from the user's (client's) system, as initiated by the Master Computer (host).

FIG. 4 shows how computers or similar systems involved in this method will typically be networked or connected, either on a permanent or as-required basis. The actual embodiment will involve many more machines, and the actual configuration will vary on a second-by-second basis, as machines come on and off line.

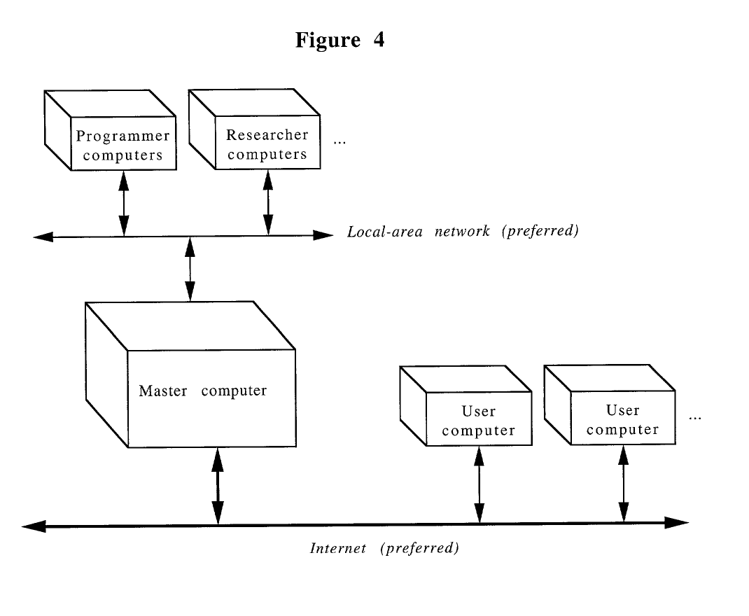

### DETAILED DESCRIPTION OF THE INVENTION

This method allows users to make requests of their computer systems in natural language, either in the form of requests, commands, or questions. For instance, the user may say or type “Show me this quarter's financial summary,” “tell me when Microsoft's stock price reaches $100,” or “Where is Botswana?”

The computer system, locally, must attempt to understand what the user has asked for. If there is software currently loaded into the system that can understand what the user has said or typed, then that software is invoked. If the software to understand what the user has requested or asked is not present in the user's local machine, then the user's computer can immediately contact the Master Computer, informing it of the request. The Master Computer then must check it's recent updates and upgrades to find out if it already knows how to handle this request. If it does have this programming, it will, depending on stored parameters, either execute the required software at the Master Computer, or transmit the software to the user's computer for immediate execution there. This latter transaction is secure because it was initiated by the user's computer, and thus, the user's computer is not accepting any unsolicited programming. However, we still have the possibility that the requested programming is not yet present on the Master Computer. In this case, the Master Computer takes the request and compares it against other pending requests from the users' computers around the world. If the request is found to be present, then the priority of that request can be increased, since it is now known that another user of the overall system needs something done. If this is a new request, it is enqueued for human intervention. (A secondary, faster, non-secure method is also described herein.)

When programmers, researchers, and/or other personnel at the Master Computer site (physically or through some network or physical notification) receive, review, and act on the queued requests, adding to the capabilities of the system overall, the Master Computer will notify all client users' computers worldwide that an upgrade is available. The users' computers then contact the Master Computer, and receive the software upgrade. Depending on connection methods and speeds, these last two steps may take place in a matter of seconds. This interaction is secure because the Master Computer neither transmits program nor data to the users' computers, only a notification of an event; in effect, an invitation to receive new software. The users' computers then initiate a secure transfer from a known and trusted source: The Master Computer. (A secondary, faster, non-secure method is also described herein.)

Once a request, command, or question is understood by virtue of having the correct and adequate software (through one or more of the methods described above), the user's computer is ready to act. If no external data is required, the user's system will act on the request or command, or answer the question immediately.

In the case of questions, or other cases where data is required, the computer system, locally, must attempt to answer the question, be it the user's direct question or an inferred question. If there is data currently loaded into the system that can answer the question at hand, then that data is used. If the data is not present in the user's local machine, then the user's computer can immediately contact the Master Computer, informing it of the question. The Master Computer then must check it's data to find out if it already knows the answer. If it does have this data, it will transmit the data to the user's computer for immediate use there. This latter transaction is secure because it was initiated by the user's computer, and thus, the user's computer is not accepting any unsolicited data. However, we still have the possibility that the requested data is not yet present on the Master Computer. In this case, the Master Computer takes the question and compares it against other pending questions from the users' computers around the world. If the question is found to be present, then the priority of that question can be increased, since it is now known that another user of the overall system needs the question answered. If this is a new question, it is enqueued for human research. (A secondary, faster, non-secure method is also described herein.)

When researchers at the Master Computer site (physically or through some network or physical notification) receive and answer the question, adding to the knowledge of the system overall, the Master Computer will notify all client users' computers worldwide that an upgrade is available. The users' computers then contact the Master Computer, and receive the data upgrade. Depending on connection methods and speeds, these last two steps may take place in a matter of seconds. This interaction is secure because the Master Computer does not transmit data to the users' computers, only a notification of an event; in effect, an invitation to receive new data. The users' computers then initiate a secure transfer from a known and trusted source: The Master Computer. (A secondary, faster, non-secure method is also described herein.)

Furthermore, programs and systems which require unscheduled but secure updates may make use of this method.

Operation—Main Embodiment

In actual operation, there are three views of how the system works:

From the viewpoint of the client-computers' users: Without this method, a user trying to use a computer system lacking a feature or information would simply be told that the system does not have the information, or that the request is not recognized. With this method, the user will be told that the information is not present yet, or that the requested feature is not present yet. At some point in the future, though, the user would be informed by the client computer or by electronic mail that the information or function is now present. Other users who might later make the same request or command would never see the operation of this method, since the data and functionality would already be in place.

Programmers, researchers, project managers, marketers, corporate managers and others working through the Master Computer will receive requests from users in a more timely manner. Without this method, new data and feature requests are very seldom made by customers, because of the extra effort involved. Those requests that are made must make their way through the bureaucratic system. With this method, such requests will be delivered within minutes to those who fill the requests.

The automatic operation of this method within the Master Computer and the client computers is described in the drawings, and the section entitled Description of the Drawings.

### DESCRIPTION OF THE DRAWINGS AND—MAIN EMBODIMENT

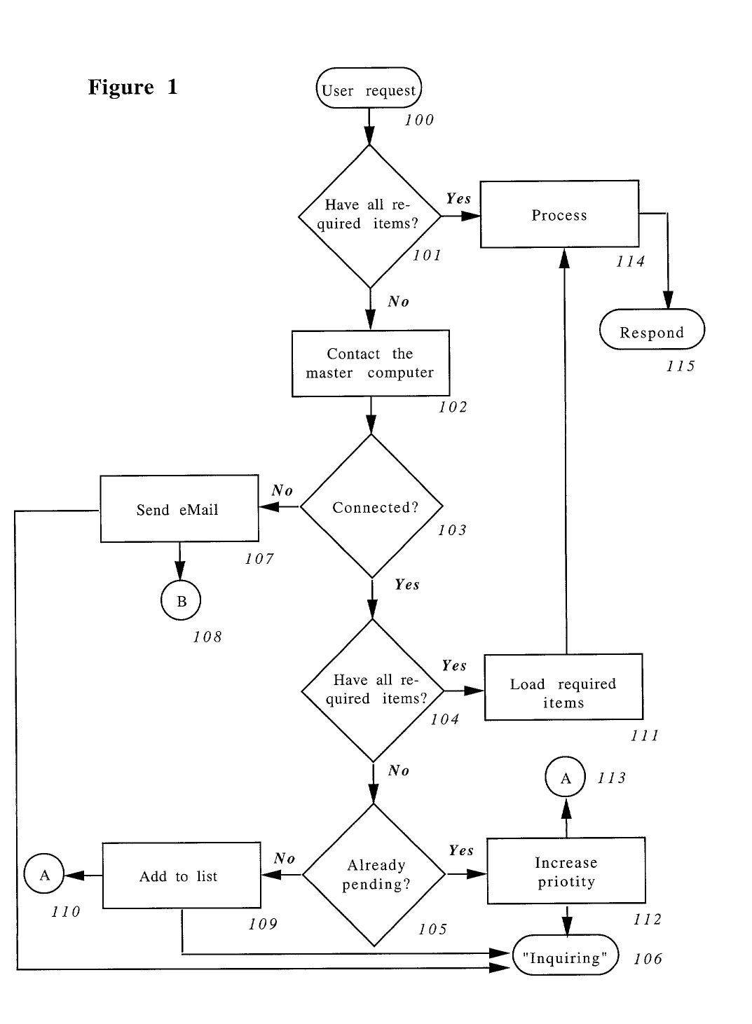

FIG. 1 is a flowchart illustrating a program and data tracking and update technique implemented by this method in a preferred embodiment. The following is a detailed description of each item:

100: The user makes a request of the system, in the form of a question, command, or request. The method in which this request is made depends on the hardware and software in use. In the simplest form, this would be line-mode entry, with a question ending in a question mark, and a command ending in a period (for natural-language syntax), or a semicolon (for computer-language syntax).

101: Here, the user's system parses the wording, and determines whether it understands the request, and has the requisite data, and any other required item, collectively known as the required “Resources”. If so, processing proceeds directly. If not, the local system must contact the Master Computer for assistance. In the simplest case, a question is answered by looking through a table to find the question. If the question is found, the corresponding answer in the table answers the question. In the simplest case of a command, the first word of a line entered can be taken as a command, and the remainder of the commands can be used as arguments. In Unix, for instance, you could pass a command to the “system” function.

102: Here, the user's computer attempts to contact the Master Computer. This can be by The Network or other means. In the simplest form, the client program initiates a TCP or similar connection to the known Master Computer's socket address.

103: Here, the user's computer determines if it has successfully connected to Master Computer. Although this is shown in the flowchart as a single decision, in actuality, the communications protocol in effect will continually check for connection, and a “no connect” decision can occur at any point during the “conversation”. If no connection is made, or the connection is dropped, the procedure continues with off-line processing. If the connection is made, or more properly, while there is a connection in effect, the procedure continues with the assistance of the Master Computer. In the above example, this would be handled by completion codes from the TCP routines.

104: The updated and/or expanded required Resources running on the Master Computer attempt to understand the wording and provide the data. If the wording can be understood by updated software, and the data and other Resources are present, then the updated programming is sent to the user's computer for continuation of the processing. If not, the Master Computer needs to request assistance from humans. In the simplest form, the programming on the Master Computer uses exactly the same methods discussed above for the client computer.

105: The Master Computer checks to see if an identical lack of Resources has already been encountered. This step is taken because in widespread use, it is likely, or at least possible, that two users on different user systems will make the same request of their computers, before appropriate Resources can be written to handle the request. If the request is found to be in the Master Computer's “to do” list, the priority should be increased. If not, the item needs to be added to the bottom of the list. This is the preferred prioritization scheme, but is not an exclusive scheme. In fact, prioritization may be skipped entirely.

106: The user is told than an inquiry is in progress, and that the system should be able to handle the request at a later time.

107: Since the assistance of the Master Computer is not immediately available to the user's computer, the user's computer sends electronic mail to the Master Computer, so that the Master Computer can act on the request in an off-line manner when a connection is made, indirectly, through The Network's mail system and/or protocol. As an example, on Unix, this could be done by invoking the “mail” program, and supplying a “Reply-to” field specific to the program implementing this method.

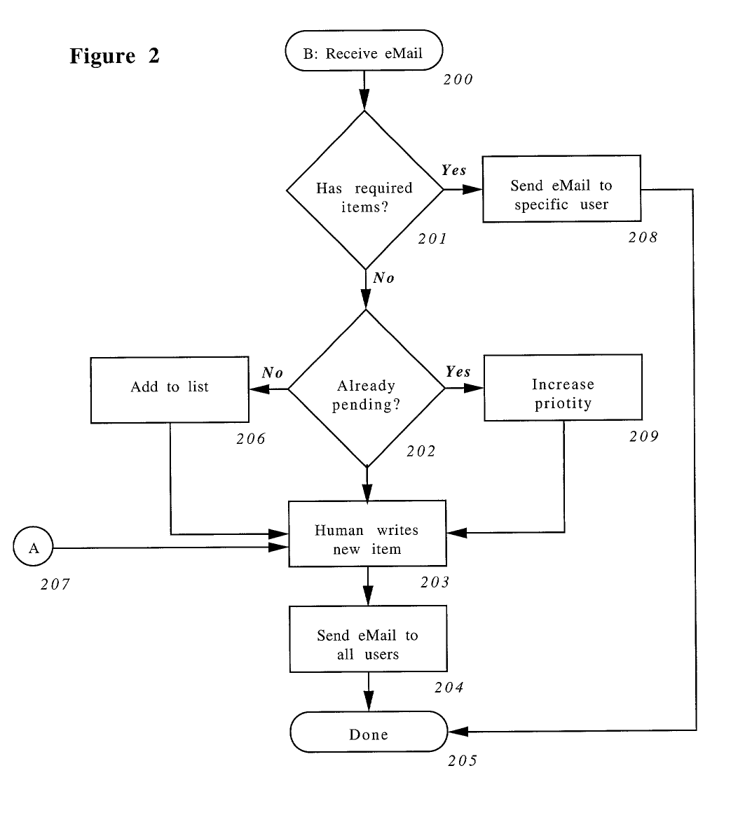

108: The process goes off-line. See FIG. 2.

109: The request is added to the Master Computer's “to do” list, for human assistance at a later time. Processing continues online with notification to the user, and off-line on FIG. 2.

110: The process goes off-line. See FIG. 2.

111: The user's computer and the Master Computer act in concert to transfer the new or improved Resource(s), most likely using an Internet method known as FTP (file transfer protocol). When this process completes, usually in a matter of seconds, the user's computer is now ready to handle the request.

112: The Master Computer increases the priority of the already-stored request for human assistance. Processing continues online with notification to the user, and off-line on FIG. 2. This step is preferred, but not required.

113: The process goes off-line. See FIG. 2.

114: The user's local computer processes the request, using Resources which had already been in place, or which have been recently received.

115: Here, the user's system responds to the user request or question.

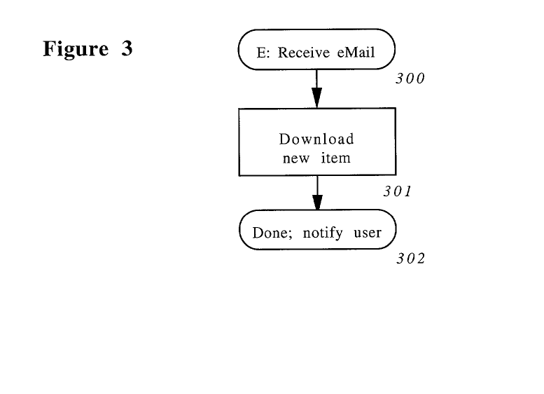

FIGS. 2 and 3 constitute a flowchart illustrating the off-line portion of a program and data tracking and update technique implemented by this method in a preferred embodiment. FIG. 2 shows the preferred method by which the Master Computer handles off-line requests for Resources. FIG. 3 shows the preferred method by which each user's computer handles update notifications. The following is a detailed description of each item:

200: A request, which was not understood by the parser on a user's computer, did not have the required data, or lacked some other resource, is received by the Master Computer, via electronic mail.

201: The updated and/or expanded Resources on the Master Computer attempt to understand the wording and find the needed data. If successful, then notification of the updated Resource set is sent to the user's computer for continuation of the processing, via electronic mail. If not, the Master Computer needs to request assistance from humans. Implementation note: For a program running on any computer to receive electronic mail, without drawing away such mail from other recipients, the program receiving the mail should have its own electronic mail address. This address should be of a name not likely to be had by other users of the system, such as “_updater@host”. To receive the mail, the program can periodically invoke the Unix “mail” program (or the local equivalent), act as a mail server on TCP port 25 (or whichever port is used locally for reception), or use a variety of other means.

202: The Master Computer checks to see if an identical lack of Resource has already been encountered. If the request is found to be in the Master Computer's “to do” list, the priority should be increased. If not, the item needs to be added to the bottom of the list. This is the preferred prioritization scheme, but is not an exclusive scheme.

203: Programmers, researchers, and/or others and their teams accept items to be done from the prioritized list of work received by the Master Computer. They will create a new Resource or modify an existing one. Once tested, this is placed into the Master Computer's Resource library for distribution to the users' systems.

204: Now that a new or updated Resource is available, all user-subscribers of the system are notified by a bulk electronic mailing that new programming is available. The Master Computer does not wait for the mail to be received. This step is a send-and-continue step.

205: The Master Computer is done with this update. The rest of the process will be handled by the users' computer upon receipt of the electronic mail.

206: The request is added to the Master Computer's “to do” list, for human assistance at a later time.

207: In this step, the Master Computer is notified by a currently connected user's computer (see FIG. 1) that human assistance is needed. The user's computer continues on with its work on FIG. 1 while processing continues in this figure.

208: While the user's computer was not connected, a new or updated Resource has become available. The user who issued the request being handled is notified by electronic mail that new programming is available. The Master Computer does not wait for the mail to be received. This step is a send-and-continue step.

209: The Master Computer increases the priority of the already-stored request for human assistance. This item is not required.

300: In the case of notification that a Resource had been entered into the Master Computer's system, one user's computer receives an electronic mail notification. In the case of a newly added or updated Resource, each users' computer receives a copy of the electronic mail notification. No program or data is contained in this message, since it cannot be adequately verified by the receiving user computer(s) that the sender of this message is legitimate.

301: This step takes on two forms, depending on whether the secure (but not as fast) embodiment is used, or the unsecured (but faster) embodiment is used.

Secure embodiment: The user's computer initiates a connection and transfer from the Master Computer into the user's computer. The preferred method is for the user's computer to initiate an anonymous FTP transfer from the Master Computer, via The Network. However, the transfer need not be anonymous, may be by some protocol other than FTP, and may involve a connection by means other than the internet. The transfer is secure, since the user's computer knows it is receiving the program or data from the Master Computer. This step may take an indefinite amount of time, since a connection to the Master Computer may not be immediately possible. Some embodiments may use multitasking or similar methods to avoid delays seen by the user.

Unsecured embodiment: The user's computer loads the new Resources contained directly within the mailed message or attached to it into the user's computer.

302: The transfer is complete. The user's computer will then notify the user, as appropriate, that the new item has arrived. This may mean that nothing immediately happens, or that the user is notified and/or that the user request completes at this point.

Conclusion Ramification, and Scope of Invention

This method will allow computer programs worldwide to learn, expand, and update as a community, and will help development and researching organizations know what their customers want, up to the minute, thus pushing technology ahead at a faster clip. All data transfers are secure, since client computers are requesting programs and data from a known and trusted source, and since the Master Computer is accepting questions and requests only, not data or programs.

There are actually several separable components which make up this method:

The method whereby client computers inform the Master Computer (and attendant personnel) which Resources are required on client computers but are not present,

The method whereby client computers' Resources are updated in a secure (or faster, unsecured) manner, and

The method whereby questions and requests previously sent to the researchers and programmers are answered, and the original users receive these answers or other resources.

Each of these items would be important in itself, but taken as a whole, give a greater sum.

1. A method by which one or a plurality of networked processors learn from the experiences of itself and/or of its peers comprising:
a. receiving, at a local processor, a request for a datum or data, and/or a program or plurality of programs, and/or a feature or a plurality of features, and/or a procedure or plurality of procedures and/or a resource or plurality of resources;
b. determining, at said local processor, if said request is immediately serviceable locally;
c. servicing the request using and/or responding with, at said local processor, said datum or data, and/or said program or plurality of programs, and/or said feature or a plurality of features, and/or said procedure or plurality of procedures and/or said resource or plurality of resources.

2. The method of claim 1 wherein said request is transmitted to a master processor or a plurality of processors via a channel of best available speed and/or other qualities, of a communication network further comprising the steps of:
a. determining at said master processor or said plurality of processors, if said request is immediately serviceable by said master processor or said plurality of processors;
b. a response is determined to said request;
c. transmitting said response to said request via said channel of best available speed and/or other qualities, of said communication network to said local processor.
d. updating, at said local processor, said datum or data, and/or said program or plurality of programs, and/or said feature or a plurality of features, and/or said procedure or plurality of procedures and/or said resource or plurality of resources according to said response.

3. The method of claim 1 wherein the request is transmitted to a master processor or a plurality of processors via a channel of best available speed and/or other qualities, of a communication network further comprising the steps of:
a. determining at said master processor or said plurality of processors that said request must be placed in a queue of requests;
b. informing an authority, either human, processor, or other designated device or object, of said request in said queue;
c. a response to said request is determined by said authority;
d. said response to said request is transmitted via said channel of best available speed and/or other qualities, of said communication network to said local processor;
e. updating, at said local processor, said datum or data, and/or said program or plurality of programs, and/or said feature or a plurality of features, and/or said procedure or plurality of procedures and/or said resource or plurality of resources according to said response.

4. The method of claim 3 further comprising the step of:
a. a notice is sent by said master processor or said plurality of processors to a subscriber or plurality of subscribers and/or client processor or plurality of client processors of the availability of said response to said request, comprised of a new datum or data, and/or a program or plurality of programs, and/or a feature or a plurality of features, and/or a procedure or plurality of procedures and/or a resource or plurality of resources.

5. The method of claim 4 further comprising the step of:
a. downloading by said subscriber or said plurality of subscribers and/or said client processor or said plurality of processors, individually and severally, of a new datum or data, and/or a program or plurality of programs, and/or a feature or a plurality of features, and/or a procedure or plurality of procedures and/or a resource or plurality of resources by any available means.
